(19) United States
(12) Patent Application Publication
(10) Pub. No.: US 2025/0060386 A1
(43) Pub. Date: Feb. 20, 2025

(54) DISPENSING UNIT

(71) Applicant: TECAN GENOMICS, INC., Redwood City, CA (US)

(72) Inventors: Sebastian Georg RAMMENSEE, Haslingfield (GB); Michael Roy FAIRS, Great Paxton, Cambs (GB)

(21) Appl. No.: 18/722,268

(22) PCT Filed: Dec. 29, 2021
(86) PCT No.: PCT/US2021/065440

§ 371 Date: Jun. 20, 2024

(51) Int. Cl. G01N 35/10

(52) U.S. Cl. CPC G01N 35/1011; G01N 35/1074; G01N 2035/103

(57) ABSTRACT

A liquid handling unit comprising: a sample unit (5) with a carrier (560) for laboratory containers (561), a liquid transfer unit (3,4) for dispensing liquid into some off the laboratory containers (561) and/or for extracting liquid from the laboratory containers (561), wherein the liquid transfer unit (3,4) being arranged above the sample unit (5) and having a holder (41) for dispensing means (43) and/or extracting means that can be raised and lowered, wherein positioning pins (46,47) being arranged on the holder (41) and positioning holes (54,55) being formed in the carrier (560), wherein with raised holder (41), the carrier (560) can pass freely below the positioning pins (46,47) in a horizontal direction and wherein with lowered holder (41), the positioning pins (46,47) can be arranged fittingly in the positioning holes (54,55).

### TECHNICAL FIELD OF THE INVENTION

The current invention relates to a dispensing unit, in particular for liquid to be dispensed from a blister arrangement into laboratory containers.

### DESCRIPTION OF THE RELATED ART

US 2019/0120868 discloses a dispensing unit with a linear movable frame on which a blister layer is arranged. For dispensing, plunges can press on the blisters. The exact positioning of the frame is realized by an index roller. In such a design, the drive of the index roller needs to be both, fast and precise, which makes it more costly. Also, the index roller has no influence on the relative positioning between the blisters and the plungers or between the blisters and the containers in which the liquid from the blisters must be dispensed, both of which are crucial for accurate dispensing processes.

### SUMMARY OF THE INVENTION

It is an object of the current invention to provide a dispensing unit for liquid to be dispensed into laboratory containers, wherein all members of the dispensing process are aligned accurately with one another with an economic alignment system.

This object is solved by a dispensing unit with the features of claim 1. Further embodiments of the dispensing unit, as well as a process for dispensing liquid with such a dispensing unit are defined by the features of further claims.

A liquid handling unit according to the invention comprises a sample unit with at least one carrier for laboratory containers and at least one liquid transfer unit for dispensing liquid into some off the laboratory containers and/or for extracting liquid from the laboratory containers. The at least one liquid transfer unit being arranged above the sample unit and having a holder for dispensing means and/or extracting means that can be raised and lowered. At least one positioning pin being arranged on the holder and at least one positioning hole being formed in the carrier, wherein with raised holder, the carrier can pass freely below the at least one positioning pin in a horizontal direction and wherein with lowered holder, the at least one positioning pin can be arranged fittingly in the at least one positioning hole. With such a design, the containers of the sample unit can be arranged roughly below the liquid transfer unit and the accurate alignment is realized in a simple manner by the positioning pins being inserted into the positioning holes. For a better centering, the positioning pins can have a conical pointed section at their bottom end and the positioning holes can have a conical flared section at their top end. For example, the positioning pins are designed as straight shafts with circular cross sections. However, other cross section shapes are also possible. The holder can be raised and lowered by means of an electromechanics drive, such as for example a spindle drive.

In one embodiment, the at least one liquid transfer unit comprises a ting unit whose holder is a vertically movable pipette holder with pipette tip receptions for pipette tips. The pipette tip receptions are arranged on a common line with the respective at least one positioning pin which line is perpendicular to said horizontal direction. This allows the accurate alignment of the pipette tips with the laboratory containers. Usually, it is desired that each pipette tip is aligned concentrically with the respective laboratory container. However, in some cases, an offset alignment can be desirable. For example, the vertically movable pipette holder is arranged on a stationary base structure.

In one embodiment, a first positioning pin being arranged on a first lateral side of the pipette tip receptions with respect to said horizontal direction and a second positioning pin being arranged on a second lateral side of the pipette tip receptions with respect to said horizontal direction, opposite the first lateral side. For example, the pipette tip receptions and the two alignment pins are arranged on a common line and the positioning pins are flanking the pipette tip receptions.

In one embodiment, the at least one liquid transfer unit comprises a plunger unit and at least one blister arrangement. The holder of the liquid transfer unit is a vertically movable plunger holder with plungers that are arranged on a common line with the respective at least one positioning pin, which line is perpendicular to said horizontal direction. The at least one positioning pin being longer than the at least one plunger. Consequently, the bottom end of the at least one positioning pin is lower than the bottom end of the at least one plunger. The at least one blister arrangement is arranged between the sample unit and the plunger unit. The blister arrangement comprises blisters that can be emptied by pressing on them with the respective plungers of the plunger unit. The blister arrangement comprises at least one positioning hole, wherein with raised holder, the blister arrangement can pass freely below the at least one positioning pin in said horizontal direction and wherein with lowered holder, the at least one positioning pin can be arranged fittingly in the at least one positioning hole. For example, the vertically movable plunger holder is arranged on a stationary base structure, which can be the same as the one for the pipette holder.

In one embodiment, a first positioning pin being arranged on a first lateral side of the plungers with respect to said horizontal direction and wherein a second positioning pin being arranged on a second lateral side of the plungers with respect to said horizontal direction, opposite the first lateral side. For example, the plungers and the two alignment pins are arranged on a common line and the positioning pins are flanking the plungers. The cross sections of the positioning pins of the plunger unit are identical to those of the ting unit and the cross sections of the positioning holes of the blister arrangement are identical to those of the sample unit.

It is understood that the dispensing unit can have one or more pipetting units together with one or more plunger units and one or more sample units.

In one embodiment, each plunger is guided by means of a linear guiding and is connected to the plunger holder by means of a compression spring, such as for example a coil spring.

In one embodiment, each plunger comprises a rigid shaft and an elastic tip. For example, the shaft comprises a mandrel, by means of which the tip is attached thereto.

In one embodiment, first positioning holes are designed as circular through holes and are arranged on a first lateral side with respect to said horizontal direction and wherein second positioning holes are designed as long holes and are arranged on a second lateral side with respect to said horizontal direction, opposite the first lateral side. With such a design, a lateral clamping of the positioning pins and the positioning holes is prevented.

In one embodiment, the liquid handling unit comprises a treatment unit that is arranged below the sample unit. The treatment unit comprises a treatment holder, which can be raised and lowered. At least one positioning pin is arranged on the treatment holder. Wherein with lowered holder, the at least one carrier of the sample unit can pass freely above the at least one positioning pin in said horizontal direction and wherein with raised treatment holder, the at least one positioning pin can be arranged fittingly in the at least one positioning hole of the sample unit. For example, the vertically movable treatment holder is arranged on a stationary base structure, which can be the same as the one for the pipette holder and the plunger holder.

In one embodiment, the treatment holder comprising heat receptions that are arranged on a common line with the respective at least one positioning pin, which line is perpendicular to said horizontal direction.

In one embodiment, a first positioning pin is arranged on a first lateral side of the treatment holder with respect to said horizontal direction and wherein a second positioning pin is arranged on a second lateral side of the treatment holder with respect to said horizontal direction, opposite the first lateral side. The cross sections of the positioning pins of treatment unit are identical to those of the plunger unit and the pipetting unit.

In one embodiment, the treatment holder comprises magnet receptions that are arranged on a common line parallel to the heat receptions.

In one embodiment, the liquid handling unit comprises a displacement unit with a first reception for the at least one sample unit. The first reception is movable in said horizontal direction, is guided by at least one first lateral guide and is driven by at least one first drive. With this design, the containers of the sample unit can be roughly arranged below the pipetting unit and/or the plunger unit and/or above the treatment unit.

In one embodiment, the displacement unit comprising a second reception for the at least one blister arrangement. The second reception is movable in said horizontal direction, is guided by at least one second lateral guide and is driven by at least one second drive. With this design, the blister arrangement can be roughly arranged below the plunger unit and/or above the sample unit. The lateral guides and the drives can be arranged on a common base structure, which can be the same as the one for the pipette holder, the plunger holder, and the movable treatment holder.

The sample unit comprises a frame with at least one reception for at least one container arrangement to be inserted from the top, wherein the at least one container arrangement comprises the at least one carrier for laboratory containers.

The frame of the sample unit can comprise an additional reception for pipette tips.

Each reception of the sample unit frame comprises lateral support surfaces or a peripheral support surface and a central recess. The container arrangements also have a peripheral support surface that is complementary to the one of the receptions of the sample unit frame. The containers of the container arrangements reach into the central recess of the corresponding reception of the sample unit frame.

The bottom part of these recesses is one selected from the group consisting of open, partially closed and completely closed. A first reception for a finished product arrangement has an open bottom part. A second reception for a pipette tip arrangement has a completely closed bottom part. A third reception for a reagent arrangement has a partially closed bottom part. A fourth reception for a reaction arrangement has an open bottom part.

If the carrier of the sample unit comprises two or more receptions, they can have different extensions in said horizontal direction and they have identical extensions perpendicular to said horizontal direction.

For storage or transportation, the sample unit can be placed on a sample unit holder.

The features of the above-mentioned embodiments of the liquid handling unit can be used in any combination unless they contradict each other.

A method for aligning components of a liquid handling unit according to the invention, comprises the steps of:
providing a liquid handling unit according to one of the preceding embodiments;
roughly positioning the at least one carrier of the sample unit below the at least one liquid transfer unit;
lowering the holder of the liquid transfer unit and thereby lowering the at least one positioning pin into the at least one positioning hole of the sample unit.

In one embodiment, the method comprises the steps of:
roughly positioning the at least one blister arrangement above the sample unit;
lowering the at least one positioning pin into the at least one positioning hole of the at least one blister arrangement before lowering them into the at least one positioning hole of the sample unit.

In one embodiment, the method comprises the steps of:
roughly positioning the at least one carrier of the sample unit above the treatment unit;
raising the treatment holder of the treatment unit and thereby raising the at least one positioning pin into the at least one positioning hole of the sample unit.

The features of the above-mentioned embodiments of the method for aligning components of a liquid handling unit can be used in any combination unless they contradict each other.

### BRIEF DESCRIPTION OF THE DRAWINGS

Embodiments of the current invention are described in more detail in the following with reference to the figures. These are for illustrative purposes only and are not to be construed as limiting. It shows

FIG. 1 a perspective longitudinal section view of a liquid handling unit according to the invention;

FIG. 2 a perspective view of the sample unit of FIG. 1 on a holder;

FIG. 3 the sample unit of FIG. 2 without holder;

FIG. 4 a longitudinal section view of the sample unit of FIGS. 2 and 3.

FIG. 5 a perspective section view of the plunger unit, the blister arrangement and the sample unit of FIG. 1 with raised plungers;

FIG. 6 the view of FIG. 5 with lowered plungers;

FIG. 7 a perspective view of the blister arrangement of FIG. 1;

FIG. 8 a perspective view of the pipetting unit of FIG. 1; and

FIG. 9 a perspective view of the treatment unit of FIG. 1.

### DETAILED DESCRIPTION OF THE INVENTION

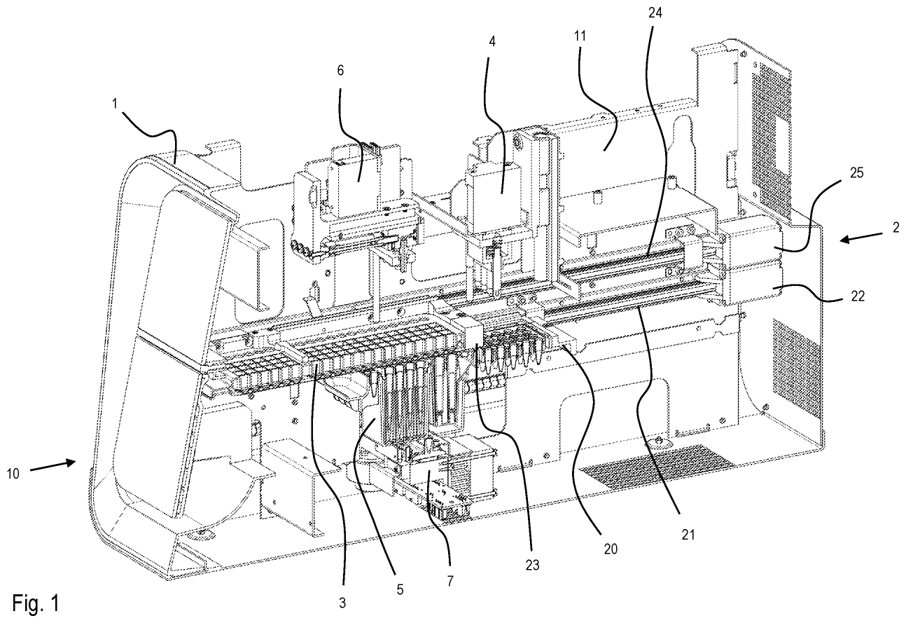

FIG. 1 shows a perspective longitudinal section view of a liquid handling unit according to the invention with a housing 1 with a closable opening 10, through which blister arrangements 3 and sample units 5 can be inserted. The opening can be closed by a downward hinged door. A status indicator in the form of a color changing light bar is arranged above the opening. A touch screen is arranged above the status indicator. There is a displacement unit 2, comprises a first guide 21 on which a first reception 20 for the sample unit 5 is movable in a horizontal direction. The first reception 20 is driven by a first drive 22. The displacement unit 2 further comprises a second guide 24 on which a second reception 23 for the blister arrangement 3 is movable in the same horizontal direction. The second reception 23 is driven by a second drive 25. The second guide, the second reception and the second drive being arranged above the first guide, the first reception and the first drive, respectively. Above the displacement unit 2, a plunger unit 4 and a pipetting unit 6 are arranged, one next to the other in said horizontal direction. Below the displacement unit 2, a treatment unit 7 is arranged. Consequently, the blister arrangement 3 and the sample unit 5 can be moved in the horizontal direction from a front side of the housing with the opening 10 towards a back side of the housing with the drives 22, 25 in planes between the upper plunger unit 4 and pipetting unit 6 and the lower treatment unit 7. The displacement unit 2, the plunger unit 4, the pipetting unit 6 and the treatment unit 7 are arranged on a common base structure 11.

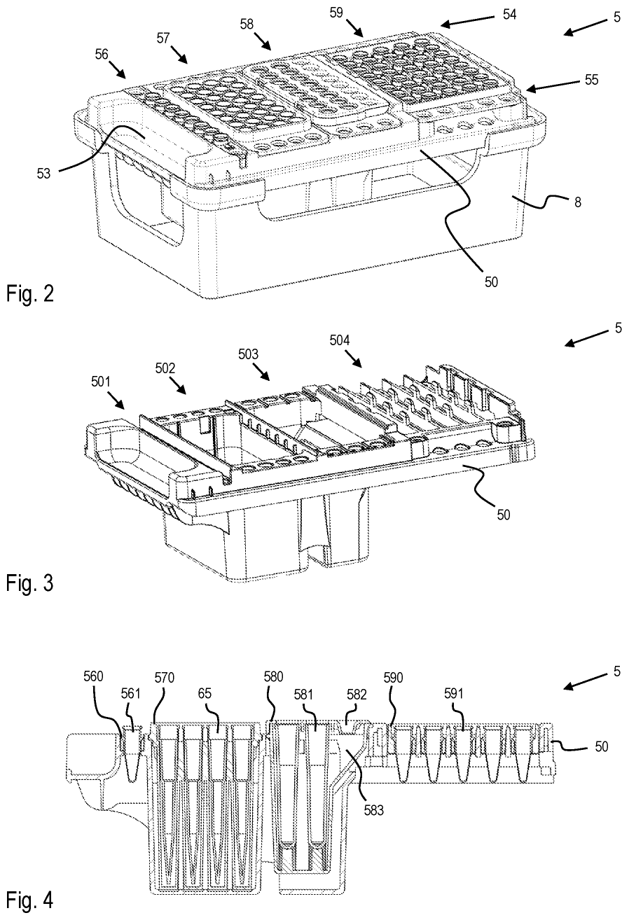

FIG. 2 shows a perspective view of the sample unit 5 of FIG. 1 on a holder corresponding sample unit holder 8, FIG. 3 shows the sample unit 5 alone, and FIG. 4 shows a longitudinal section view of the sample unit of FIGS. 2 and 3. The sample unit comprises a frame 50 with several receptions 501,502,503,504 for corresponding container arrangements 56, 57, 58, 59 and with a handle 53. In the horizontal direction, the handle 53 is arranged on one side, which faces the opening of the housing when inserted into the first reception of the displacement unit. A first reception 501 holds a finished product arrangement 56, a second reception 502 holds a pipette tip arrangement 57, a third reception 503 holds a reagent arrangement 58 and a fourth reception 504 holds a reaction arrangement 59. The finished product arrangement 56 comprises a finished product carrier 560 with several finished product containers 561, arranged on a single line. The finished product containers are connected to each other and form a common strip at both ends of which, a dovetail is formed. After processing, the finished product container strip can be placed in a downstream processing apparatus, for example in a gen sequencer. The finished product carrier 560 has an open bottom, through which the containers are accessible from below. The pipette tip arrangement 57 has four parallel lines of pipette tips 65 that are arranged in a closed pipette tip carrier 570. A closed circumferential collar surrounds the area of the pipette tips. A tear-off film is arranged on the collar that needs to be removed manually before inserting the sample unit into the liquid handling unit. The reagent arrangement 58 has two parallel lines of reagent containers 581 and parallel thereto one line of disposal openings 582 that are arranged in a closable reagent carrier 580. The reagent carrier has a closed lower part and a hinged lid comprising the openings. For example, the lower part and the lid are formed integrally in a single piece by injection molding. The inside of the reagent carrier 580 forms a waste container 583 that is accessible from above by the disposal openings 582. Excess liquid can be dispensed into the waste container 583 through the disposal openings 582. The top of each reagent container is sealed by a film, which, for example, is pierced with the respective pipette tip when accessed for the first time. For example, the film is a thin metal foil, such as an aluminum foil or a plastic foil. The reaction arrangement 59 has five parallel lines of reaction containers 591 that are arranged in a reaction carrier 590 with an open bottom. The reaction containers are held in place in the reaction carrier by means of catches, preventing them from being lifted out of it, when a force is applied on them from below. The top of each reaction container is sealed by a film, which, for example, is pierced with the respective pipette tip when accessed for the first time. For example, the film is a thin metal foil or plastic foil. The reaction containers are connected to each other and form a common strip. A dovetail is formed on at least one end of the strip. In the fourth reception 504, between two adjoining strips of reaction containers, a web with hooks is provided that extends between the two lateral sides of the fourth reception. The hooks lock the reaction carrier in place and prevent it from being lifted out of the frame 50, when a force is applied on the reaction containers 591 from below. The reaction carrier 590 has slits, through which the top of the hooks can pass. For inserting, the reaction carrier must be inserted in the frame 50 with a small offset to the back of the frame. After the reaction carrier rests on the frame, i.e., on the lateral support surfaces and the top of the webs, the reaction carrier needs to be pushed towards the front side of the frame for locking. Forces on the reaction containers can occur when they are inserted into receptions of treatment unit for heat treatment or for magnetic treatment, such as magnetic bead separation. The widths of all carriers 560,570,580,590 are identical and at each line a first positioning hole 54 is arranged on one lateral side thereof and a second positioning hole 55 is arranged on the other lateral side thereof. The first reception 501 and the fourth reception 504 having open bottom parts, the second reception 502 having a completely closed bottom part and the third reception 503 having a partially closed bottom part.

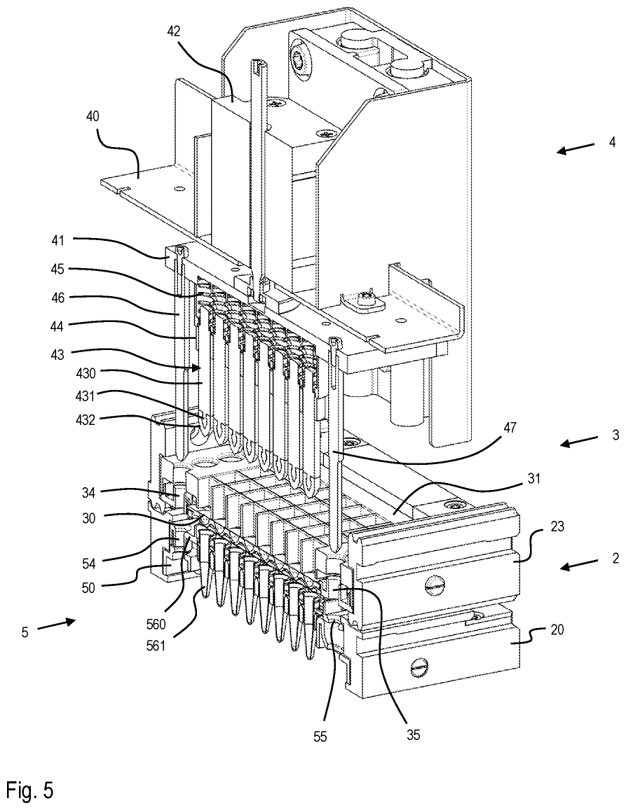

FIG. 5 shows a perspective section view of the plunger unit 4, the blister arrangement 3 and the sample unit 5 of FIG. 1 with raised plungers 43. The plunger unit 4 has a stationary base 40 on which a vertically movable plunger holder 41 is arranged. The plunger holder 41 can be raised and lowered by means of a drive 42; depicted is an electromechanical spindle drive. Each plunger 43 is arranged in a linear guiding 44 that is arranged on the plunger holder 41. A compression spring 45 is arranged in the linear guiding 44 between each plunger 43 and the plunger holder 41. Each plunger 43 has a rigid straight shaft 430 with a mandrel 431 at its lower end and with a flexible tip 432 arranged on the mandrel 431. A first positioning pin 46 is arranged in line with the line of plungers 43, on one lateral side thereof and a second positioning pin 47 is arranged in line therewith on the other side thereof. The sample unit 5 is arranged in the first reception 20 of the displacement unit 2 and the first and second positioning holes 54,55 of the sample unit 5 are roughly aligned with the corresponding first and second positioning pins 46,47 of the plunger unit 4. The blister arrangement 3 is arranged in the second reception 23 of the displacement unit 2 and the first and second positing holes 34,35 of the blister arrangement are roughly aligned with the corresponding first and second positioning pins 46,47 of the plunger unit 4.

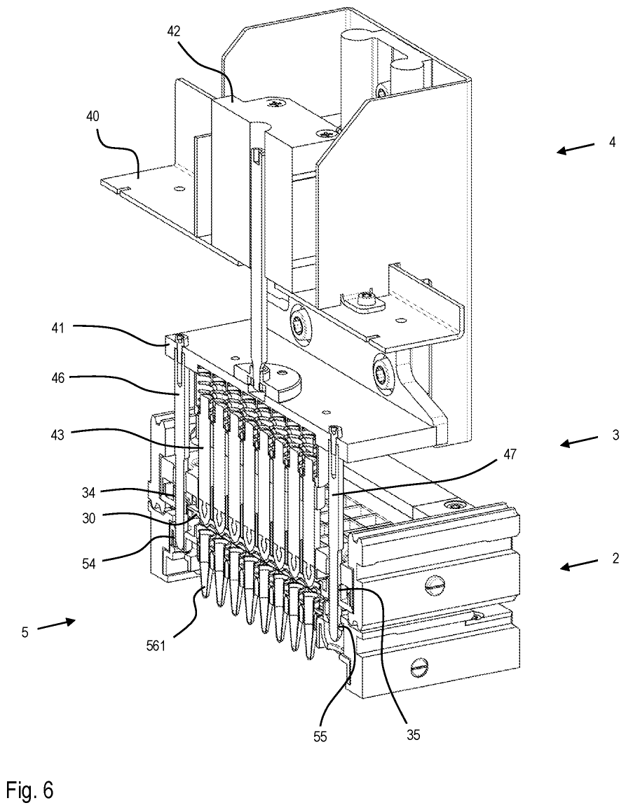

FIG. 6 shows the same components as FIG. 5, but with lowered plungers 43. The first positioning pin 46 of the plunger unit 4 is fittingly arranged in the first positing hole 34 of the blister arrangement 3 and the first positioning hole 54 of the sample unit 5 and the second positioning pin 47 of the plunger unit 4 is fittingly arranged in the second positioning hole 35 of the blister arrangement 3 and the second positioning hole 55 of the sample unit 5, thereby accurately aligning the plungers 43 of the plunger unit 4 with the blister strip 30 of the blister arrangement 3 and with the respective container of the sample unit 5. Depicted is a finished product container 561. However, the other containers of the sample unit can be aligned in the same way. The tips 432 of the plunger 43 press on the blister strip 30 of the blister arrangement 3. The liquid of the blister strip 30 is thereby dispensed into the finished product container 561.

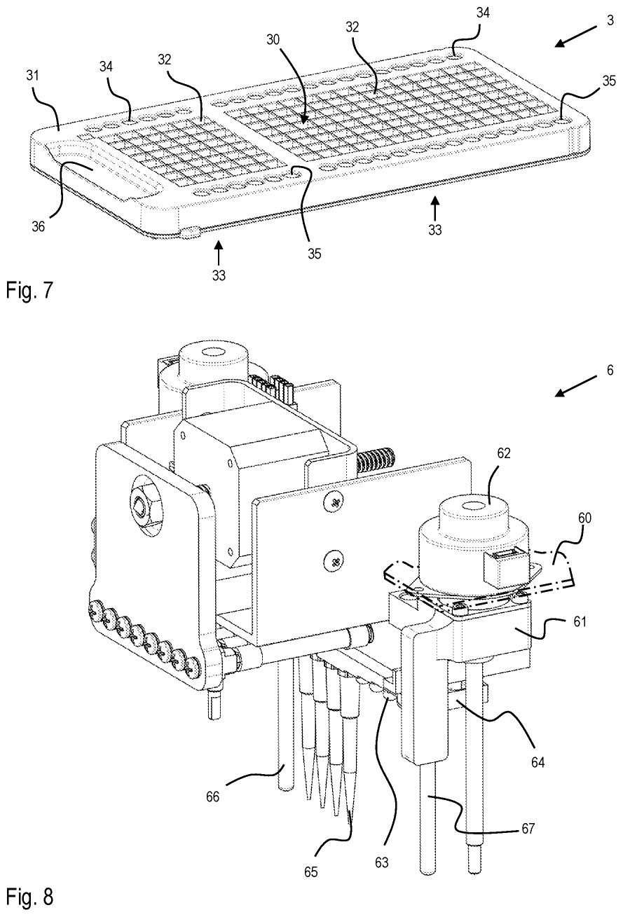

FIG. 7 shows a perspective view of the blister arrangement 3 of FIG. 1. It comprises blister strips 30 that are enclosed in a cartridge 31, wherein each blister strip comprises several blisters that are arranged on a common line. Each blister is filled with a liquid to be dispensed and has a nozzle at its bottom. Each blister is accessible from the top through corresponding top openings 32 and is accessible from the bottom through corresponding bottom openings 33 that are formed in the cartridge 31. at each blister strip 30, i.e., at each line of blisters, a first positioning hole 34 is arranged on one lateral side thereof and a second positioning hole 35 is arranged on the other lateral side thereof. In the horizontal direction, a handle 36 is arranged on one side, which faces the opening of the housing when inserted into the second reception of the displacement unit.

FIG. 8 shows a perspective view of the pipetting unit 6 of FIG. 1. The pipetting unit 6 allowing the dispensing of liquids into containers of the sample unit and the extraction of liquids therefrom. The pipetting unit 6 has a stationary base 60 on which a vertically movable pipette holder 61 is arranged. The pipette holder 61 can be raised and lowered by means of a drive 62; depicted is an electromechanical spindle drive. Several pipette tip receptions 63 are arranged on a common line on the pipette holder 61. At each tip reception 63, a pipette tip 65 can be plugged on from below. A tip stripper 64 is arranged on the pipette tip holder 61, allowing the automatic removal of each pipette tip 65 from the corresponding pipette tip reception 63. On the pipette holder 61, a first positioning pin 66 is arranged on one lateral side of the line of pipette tip receptions 63 and a second positioning pin 67 is arranged on the other lateral side thereof. During the reception and the release of the pipette tips, the positioning pins engage the corresponding positioning holes of the sample unit. The pipette tips can be re-used and can be stored in the sample unit intermediately.

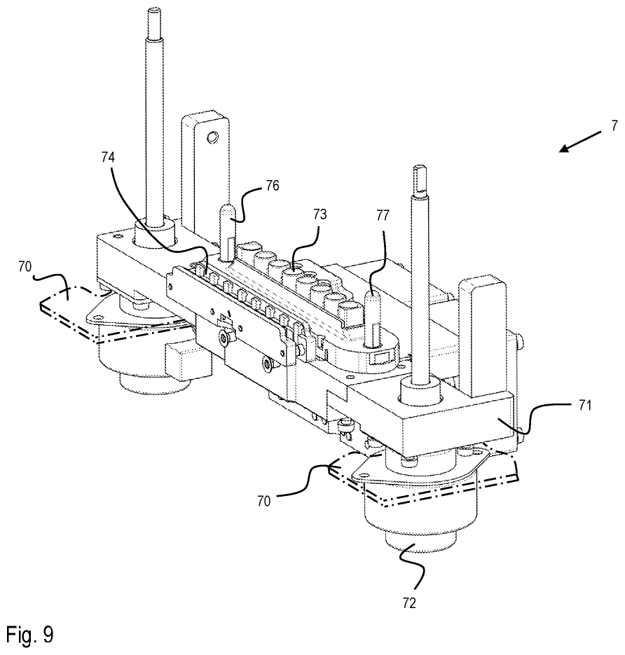

FIG. 9 shows a perspective view of the treatment unit 7 of FIG. 1. The treatment unit 7 has a stationary base 70 on which a vertically movable treatment holder 71 is arranged. The treatment holder 71 can be raised and lowered by means of a drive 72; depicted is an electromechanical spindle drive. Several heat receptions 73 are arranged on a common line on the treatment holder 71. The heat receptions allowing the heating of liquids in containers of the sample unit. On the treatment holder 71, a first positioning pin 76 is arranged on one lateral side of the line of heat receptions 73 and a second positioning pin 77 is arranged on the other lateral side thereof. Several magnet receptions 74 are arranged on the treatment holder 71 on a common line, parallel to the line of heat receptions 73. The magnet reception allowing the application of a magnetic field on the content of containers of the sample unit. The line of the magnet reception is offset to the one of the heat reception by a pitch of two adjoining positioning holes or a multiple thereof.

### REFERENCE SIGNS LIST

1 housing 45 spring
10 opening 46 first positioning pin
11 base structure 47 second positioning
2 displacement unit pin
20 first reception 5 sample unit
21 first guide 50 frame
22 first drive 501 first reception
23 second reception 502 second reception
24 second guide 503 third reception
25 second drive 504 fourth reception
3 blister arrangement 53 Handle
30 blister strip 54 first positioning
31 cartridge hole
32 top opening 55 second positioning
33 bottom opening hole
34 first positioning 56 finished product hole arrangement
35 second positioning 560 finished product hole carrier
36 handle 561 finished product
4 plunger unit container
40 base 57 pipette tip
41 plunger holder arrangement
42 plunger drive 570 pipette tip carrier
43 plunger 58 reagent arrangement
430 shaft 580 reagent carrier
431 mandrel 581 reagent container
432 tip 582 disposal opening
44 linear guiding 583 waste container
59 reaction arrangement 7 treatment unit
590 reaction carrier 70 base
591 reaction container 71 treatment holder
6 pipetting unit 72 drive
60 base 73 heat reception
61 pipette holder 74 magnet reception
62 vertical drive 76 first positioning pin
63 tip reception 77 second positioning
64 tip stripper pin
65 pipette tip 8 sample unit holder
66 first positioning pin
67 second positioning pin

1. A liquid handling unit including:
a sample unit (5) with at least one carrier (560;580;590) for laboratory containers (561;581;591),
at least one liquid transfer unit (3,4;6) for dispensing liquid into at least some of the laboratory containers (561;581;591) and/or for extracting liquid from the laboratory containers (561;581;591), the at least one liquid transfer unit (3,4;6) being arranged above the sample unit (5) and having a holder (41;61) for dispensing means (43;63,65) and/or extracting means (63,65) that can be raised and lowered,
at least one positioning pin (46,47;66,67) is arranged on the holder (41;61) and at least one positioning hole (54,55) is formed in the carrier (560;580;590),
wherein when the holder (41; 61) is raised, the carrier (560;580;590) passes freely below the at least one positioning pin (46,47;66,67) in a horizontal direction and wherein when the holder (41;61) is lowered, the at least one positioning pin (46,47;66,67) can be arranged fittingly in the at least one positioning hole (54,55).

2. The liquid handling unit according to claim 1, wherein the at least one liquid transfer unit includes a pipetting unit (6) whose holder is a vertically movable pipette holder (61) with pipette tip receptions (63) for pipette tips (65), which pipette tip receptions (63) are arranged on a common line with the respective at least one positioning pin (66,67), which line is perpendicular to said horizontal direction.

3. The liquid handling unit according to claim 2, wherein a first positioning pin (66) being arranged on a first lateral side of the pipette tip receptions (63) with respect to said horizontal direction and wherein a second positioning pin (67) being arranged on a second lateral side of the pipette tip receptions (63) with respect to said horizontal direction, opposite the first lateral side.

4. The liquid handling unit according to claim 1, wherein the at least one liquid transfer unit includes a plunger unit (4) and at least one blister arrangement (3), wherein the holder of the liquid transfer unit is a vertically movable plunger holder (41) with plungers (43) that are arranged on a common line with the respective at least one positioning pin (46,47), which line is perpendicular to said horizontal direction, and whereby the at least one blister arrangement (3) that is arranged between the sample unit (5) and the plunger unit (4), wherein the blister arrangement (3) including blisters (30) that can be emptied by pressing on them with the respective plungers (43) of the plunger unit (4) and comprising at least one positioning hole (34,35), wherein with raised holder (41), the blister arrangement (3) can pass freely below the at least one positioning pin (46,47) in said horizontal direction and which with lowered holder (41), the at least one positioning pin (46,47) can be arranged fittingly in the at least one positioning hole (34,35).

5. The liquid handling unit according to claim 4, wherein a first positioning pin (46) being arranged on a first lateral side of the plungers (43) with respect to said horizontal direction and wherein a second positioning pin (47) being arranged on a second lateral side of the plungers (43) with respect to said horizontal direction, opposite the first lateral side.

6. The dispensing unit according to claim 4, wherein each plunger (43) is guided by means of a linear guiding (44) and is connected to the plunger holder (41) by means of a compression spring (45).

7. The liquid handling unit according to claim 4, wherein each plunger (43) includes a rigid shaft (430) and an elastic tip (432).

8. The liquid handling unit according to claim 1, wherein first positioning holes (34;54) are designed as circular through holes and are arranged on a first lateral side with respect to said horizontal direction and wherein second positioning holes (35;55) are designed as long holes and are arranged on a second lateral side with respect to said horizontal direction, opposite the first lateral side.

9. The liquid handling unit according to claim 1, comprising a treatment unit (7) that is arranged below the sample unit (5), wherein the treatment unit (7) comprising a treatment holder (71), which can be raised and lowered, wherein at least one positioning pin (76,77) being arranged on the treatment holder (71), wherein with lowered treatment holder (71), the at least one carrier (560;580;590) of the sample unit (5) can pass freely above the at least one positioning pin (76,77) in said horizontal direction and wherewith raised treatment holder (71), the at least one positioning pin (76,77) can be arranged fittingly in the at least one positioning hole (54.55) of the sample unit (5).

10. The liquid handling unit according to claim 9, wherein the treatment holder (71) including heat receptions (73) that are arranged on a common line with the respective at least one positioning pin (76,77), which line is perpendicular to said horizontal direction.

11. The liquid handling unit according to claim 10, wherein a first positioning pin (76) being arranged on a first lateral side of the treatment holder (71) with respect to said horizontal direction and wherein a second positioning pin (77) being arranged on a second lateral side of the treatment holder (71) with respect to said horizontal direction, opposite the first lateral side.

12. The liquid handling unit according to claim 11, wherein the treatment holder (71) including magnet receptions (74) that are arranged on a common line parallel to the heat receptions (73).

13. The liquid handling unit according to claim 1, comprising a displacement unit (2) with a first reception (20) for the at least one sample unit (5), in which the first reception (20) is movable in said horizontal direction, is guided by at least one first lateral guide (21) and is driven by at least one first drive (22).

14. The liquid handling unit according to claim 4, wherein the displacement unit (2) comprising a second reception (23) for the at least one blister arrangement (3), wherein the second reception (23) is movable in said horizontal direction, is guided by at least one second lateral guide (24) and is driven by at least one second drive (25).

15. A method for aligning components of the liquid handling unit of claim 1, including the steps of:
roughly positioning the at least one carrier (560;580;590) of the sample unit (5) below the at least one liquid transfer unit (3,4;6); and
lowering the holder (41;61) of the liquid transfer unit (3,4;6) and thereby lowering the at least one positioning pin (46,47;66,67) into the at least one positioning hole (54,55) of the sample unit (5).

16. The method according to claim 15, including the steps of:
roughly positioning the at least one blister arrangement (3) above the sample unit (5); and
lowering the at least one positioning pin (46,47;66,67) into the at least one positioning hole (34.35) of the at least one blister arrangement (3) before lowering them into the at least one positioning hole (54.55) of the sample unit (5).

17. The method according to claim 15, including the steps of:
roughly positioning the at least one career (560;580;590) of the sample unit (5) above the treatment unit (7); and
raising the treatment holder (71) of the treatment unit (7) and thereby raising the at least one positioning pin (76,77) into the at least one positioning hole (54,55) of the sample unit (5).
